(19) United States
(12) Patent Application Publication
(10) Pub. No.: US 2002/0062371 A1
(43) Pub. Date: May 23, 2002

(54) Method to provide a network environment and system of the same

(75) Inventor: Goh Itoh, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Toshiba, Kawasaki-shi (JP)

(21) Appl. No.: 09/813,215

(22) Filed: Mar. 21, 2001

(30) Foreign Application Priority Data
Sep. 28, 2000 (JP) 2000-297435

(51) Int. Cl. G06F 15/173

(52) U.S. Cl. 709/225; 709/224

(57) ABSTRACT

The invention is method for providing a network environment as requested from a plurality of clients. This method is comprising: receiving a request to provide said network environment from one of said clients, setting an individual network for each of said clients requesting to provide a closed network in response to the received request and informing to said client of use permission with a predetermined discriminator and an access priority, and managing a use time of the closed network.

### CROSS REFERENCE TO RELATED APPLICATION

This application claims benefit of priority from the Japanese Patent Application No.2000-297435, filed on Sep. 28, 2000, the entire contents of which are incorporated by reference herein.

### BACKGROUND OF THE INVENTION

1. Field of the Invention

The present invention relates to a method to provide a network environment and a system thereof suited to a case that a plurality of users perform jobs to aim at the same object.

2. Description of the Related Art

As conventional method for executing information exchange by a plurality of clients, a chat, mailing list, and electronic bulletin board system may be cited. Comparison results of these information exchange methods from various viewpoints are shown in Table 1.

TABLE 1
The superiority and inferiority table

| | | <mailing | |
|---|---|---|---|
| <properties> | <chat> | list> | <BBS> |
| Information | X | X | X |
| adjustment¹⁾ | | | |
| Packet volume²⁾ | ◯ | Δ | X |
| Real time³⁾ | ◯ | Δ | X |
| Easiness to write⁴⁾ | Δ | Δ | X |
| Address designation | Δ | ◯ | X |
| ⁵⁾ | | | |
| Access in congestion | Δ | Δ | X |
| ⁶⁾ | | | |
| Use of special | Δ | X | X |
| function⁷⁾ | (using soft) | | |

¹⁾:◯;It depends on clients. X;It depends on sending order.
²⁾:◯;Only renewal part. Δ;Personal setting is liable to be inserted into contents. X;All pages.
³⁾:◯;Abrupt change. Δ;Mail opening is needed. X;Renewal is needed.
⁴⁾:◯;Clients are able to rewrite a part of contents. Δ;Sequential write. X;Designate return subjects.
⁵⁾:◯;All address is known. Δ;site control. X;Selective address designation is impossible.
⁶⁾:◯;IP address priority system is available to improve access speed. Δ;Access speed doesn't change very much because of merit of few participant. X;Access speed change very much because of many participant.
⁷⁾:◯;It is available because of merit of using the same server and adjusting environment. X;It is unavailable because of different servers.

The superiority and inferiority table puts emphasis on “operation environment between extremely limited group users”, so that the table is not always suitable depending on the object.

Table 1 shows that when a plurality of users are to perform jobs corroboratively in a short term to aim at the same object, no suitable tool is prepared. Further, when the number of clients accessing a network increases, the access speed greatly falls due to a network jam and the network environment is not in a condition to perform a real-time processing.

On the other hand, between clients in different servers, it is difficult to provide the software with special functions.

As mentioned above, there are conventionally no suitable tools available at the time of performing jobs corroboratively in a short term to aim at the same object.

### SUMMARY OF THE INVENTION

An object of the present invention is to provide a method to provide a network environment and a system thereof for giving access priority to a network to a client within the time designated by him and improving the real-time processing in a short-term corroboration job.

According to an aspect of the present invention there is provided a method f or providing a network environment from a server as requested from a plurality of clients and the server sets an individual network for a request to provide a network environment from each client, informs him of use permission of a predetermined address, gives him access priority to the network, and also manages the use time of the network.

### BRIEF DESCRIPTION OF THE DRAWINGS

FIG. 1 is a block diagram showing a client and a server of a system according to an embodiment of the present invention.

FIGS. 2 and 3 show flaw charts of a mini LAN service according to the,embodiment.

FIG. 4 is a drawing showing the assignment of a client file name and an IP address according to the embodiment.

FIG. 5 is a flaw chart showing the LAN access control according to the embodiment.

FIG. 6 is a flaw chart showing the preparation procedure of an environment setting file according to the embodiment.

FIG. 7 is a flaw chart showing the reservation receiving procedure according to the embodiment.

FIG. 8A shows examples of an application form of the embodiment.

FIG. 8B shows examples of an entered form of the embodiment.

FIG. 9 is a drawing showing a packet constitution example of the embodiment.

FIG. 10A is a drawing showing a display file description example of the embodiment.

FIG. 10B is a display example of the embodiment.

FIG. 11 is a drawing showing a procedure (an example at the time of rewriting) to be performed at the time of using the software of the embodiment.

FIG. 12 is a drawing showing a rewritten packet constitution example according to the embodiment.

FIG. 13 is a drawing showing contents of a display file description example according to the embodiment.

FIG. 14 is a drawing showing a display example before and after conversion according to the embodiment.

FIG. 15 is a drawing showing the conversion method at the time of use of another software (image display effect) of the embodiment.

FIG. 16 is a drawing showing display file description after conversion at the time of use of another software (image display effect) of the embodiment.

FIG. 17A is a drawing showing a display example having no marker at the time of use of another software (image display effect) of the embodiment.

FIG. 17B is a drawing showing a display example having a marker at the time of use of another software (image display effect) of the embodiment.

FIG. 17C is a drawing showing a display example having composite pattern at the time of use of another software (image display effect) of the embodiment.

FIG. 18A is a drawing showing a display example having a thin marker at the time of use of another software (image display effect) of the embodiment.

FIG. 18B is a drawing showing a display example having a thin marker and a thick marker at the time of use of another software (image display effect) of the same embodiment.

FIG. 18C is a drawing showing a display example having composite pattern at the time of use of another software (image display effect) of the embodiment.

FIG. 19 is a drawing showing the transmission and link processing procedure of the main program and subprogram relating to the embodiment.

FIG. 20 is a drawing showing the calculation procedure of the use time, end time, and use charge according to the embodiment.

FIG. 21 is a drawing showing the billing procedure according to the embodiment.

FIG. 22 is a drawing for explaining the description method used in each procedure according to the embodiment.

### DESCRIPTION OF THE EMBODIMENTS

The respective embodiments which are illustrative but not limited will be explained hereunder, thereby the contents of the present invention will be made clear.

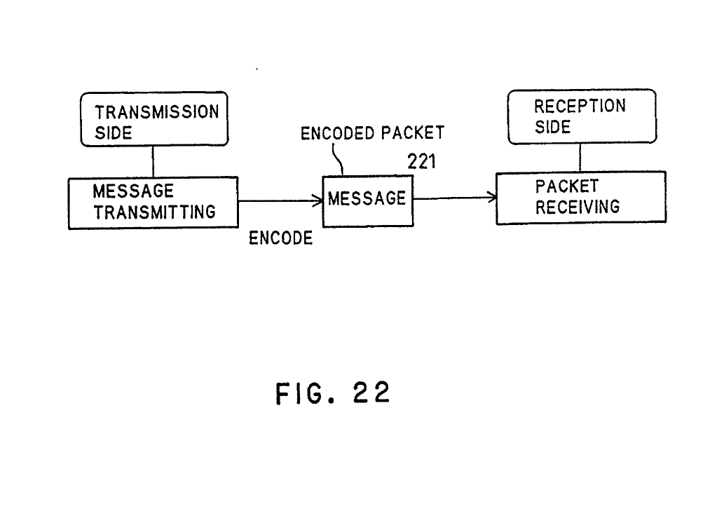

The notation in the drawings is that as shown in FIG. 22, at the message transmission step of preparing and transmitting a message to be transmitted from the transmission side, the message is transmitted to the communication network as an encoded packet 221 and the reception side receives the packet and then decodes it.

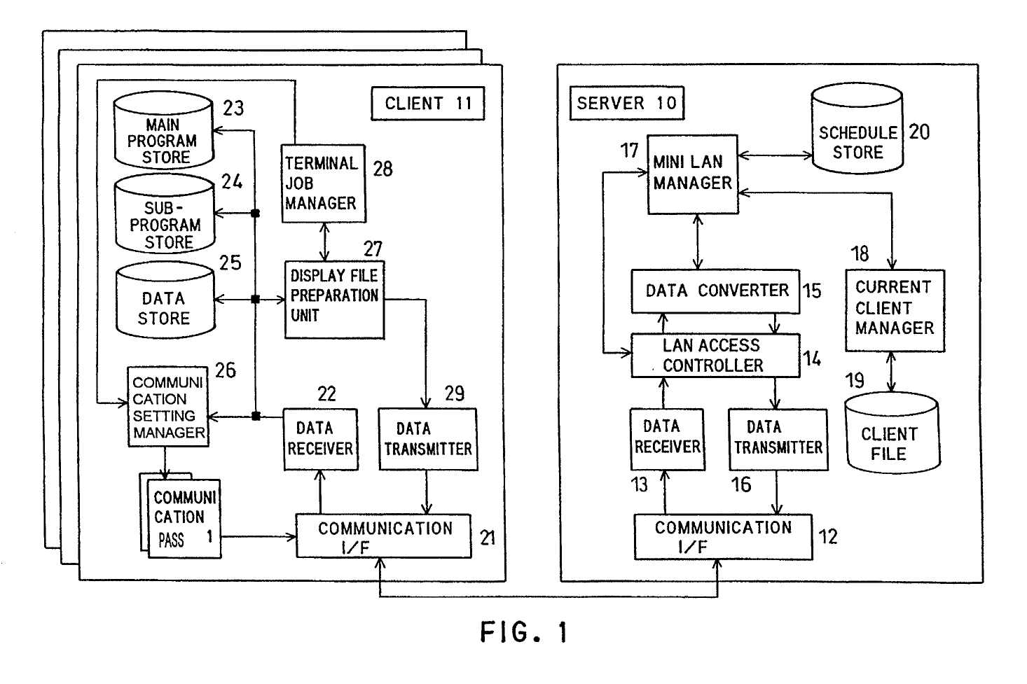

FIG. 1 shows an example of a server 10 and a client 11 of a network environment system (hereinafter, called a mini LAN) according to one embodiment of the present invention.

In the drawing, the server 10 receives a packet transmitted from the client 11 via a communication interface 12. The received packet is received and decoded by a data receiver 13 and transmitted to a local area network (hereinafter, called a LAN).

The packet includes an Internet address (hereinafter, called an IP address) indicating the transmission source. The IP address will be described later.

A packet from the server 10 is converted by a data converter 15, which will be described later, via a LAN access controller 14. Thereafter, it is transmitted and encoded by a data transmitter 16 and transmitted to the client via the communication interface 12.

To solve collisions of a plurality of packets transmitted on the LAN at the same time, the server 10 has the LAN access controller 14, decides the access priority by the IP address, and permits the packet with higher priority to be transmitted on the LAN.

The LAN access controller 14 is managed by a mini LAN manager 17 and information on which IP address is to be given priority is transmitted from the mini LAN manager 17 to the LAN access controller 14.

The aforementioned information is prepared by the mini LAN manager 17 by a method, which will be described later, according to data from a current client manager 18 for managing clients under contract at present and a client file 19. Further, a schedule store 20 is prepared so as to confirm the service condition and service reservation condition.

On the other hand, the side of the client 11 receives a packet transmitted from the server 10 via a communication interface 21 and a data receiver 22 receives and decodes the received packet.

Each packet includes the main program and subprograms so as to use the software supplied from the server 10 and various data to be actually displayed on the display of the terminal. These data are respectively stored in the memory (a main program store 23, a subprogram store 24, a data store 25) in the terminal.

Communication setting data for enabling communication with the server 10 is also transmitted and recorded in a communication setting manager 26 and a connection environment setting file is prepared. In the connection environment setting file, the domain name, domain address, client name, IP address, dial-up telephone number, gate way address, password and so on are set depending on the connection environment.

In this embodiment, the client name (may be called the user name) and discriminator are particularly important. Here, a case that the IP address is used as a discriminator will be explained.

A communication pass is structured according to the connection environment setting file and when a plurality of communication passes can be used, switching of the communication pass is instructed from the communication setting manager 26, so that the mini LAN can be used together with other communication objects (telephone, mail, etc.).

The client 11 has a display file preparation unit 27 for starting the main program and subprograms and rewriting data in a display file format capable of displaying data and can execute insertion on the display screen, overwriting, display, calculation, and display processing by a means which will be described later.

Up-data by a terminal job manager 28 of the client 11 is converted to the data format used in the mini LAN by the display file preparation unit 27, and transmitted and encoded by a data transmitter 29, and then transmitted to the server 10 via the communication interface 21.

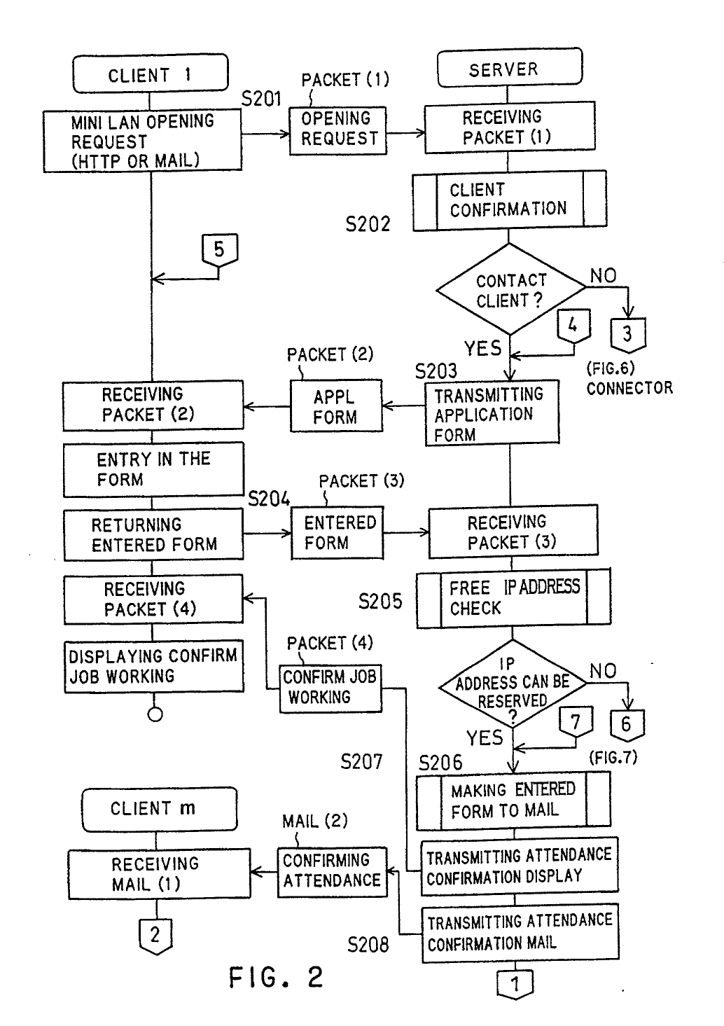

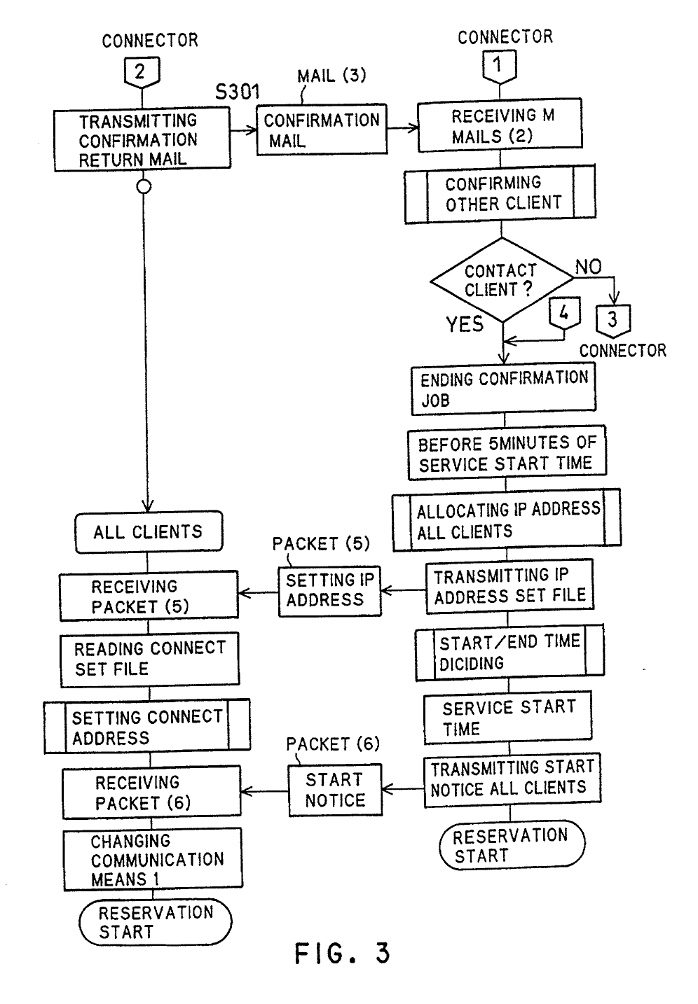

FIGS. 2 and 3 show the flow of processing from mini LAN opening request to service start for each of the client and server. Here, a case is shown that a plurality of clients (hereinafter, called a group) perform the same job at the same time and the client 1 decides on the initial procedure and billing method with the server 10 as a representative of the group.

A client m (m indicates an integer more than 1) in the flow chart means another client in the group except the client 1 and whole clients mean all the clients in the group.

Firstly, the flow of processing up to service start will be explained.

The client 1 informs the server of a mini LAN opening request by mail (step S 201). Even when the server prepares a mini LAN site on the Internet, the same operation can be performed. The opening request mail (1) is transmitted to the server.

When the client is a client registered in the name server (hereinafter, called a contract client) by the domain name system (hereinafter, called DNS) on the server, an exclusive packet which can be used between the contract client and the server can be used and the opening request packet (1) is transmitted to the server.

The server decides the client 1 (a contract client, or contract provider client, or the other clients) by the client confirmation (program, step, device, unit, . . . ) (step S202).

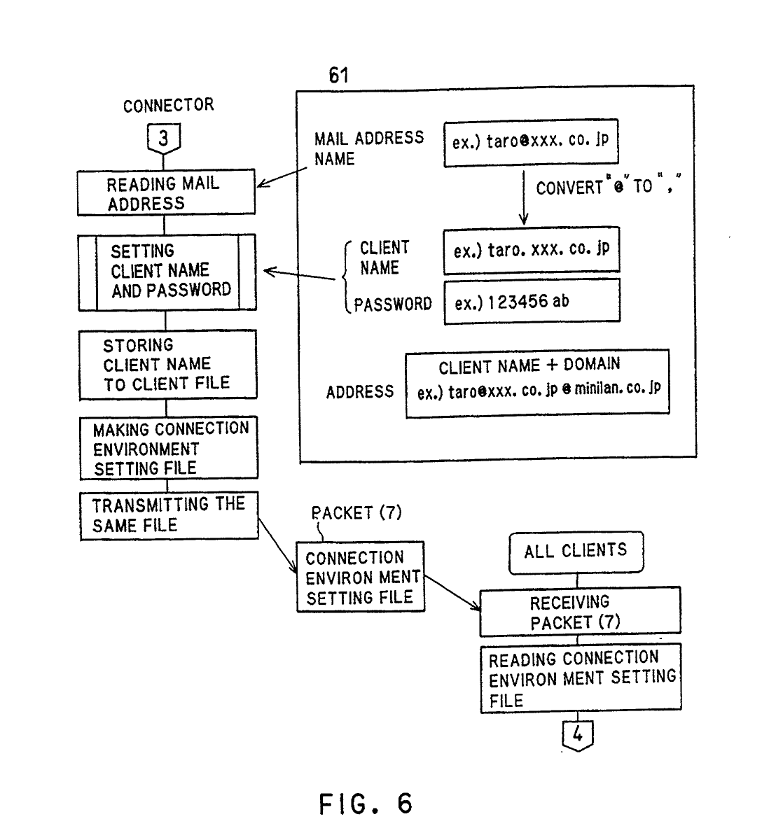

The contract provider client is a client managed by the DNS of another provider with whom a contract is made on the billing method. When the client 1 is a contract client, the process goes to the application form transmission step, while when the client 1 is not a contract client, he is set to a time contract client(a client who is managed by the DNS of the server only during use of the mini LAN) using a step (connector 3→connector 4; FIG. 6) which will be described later.

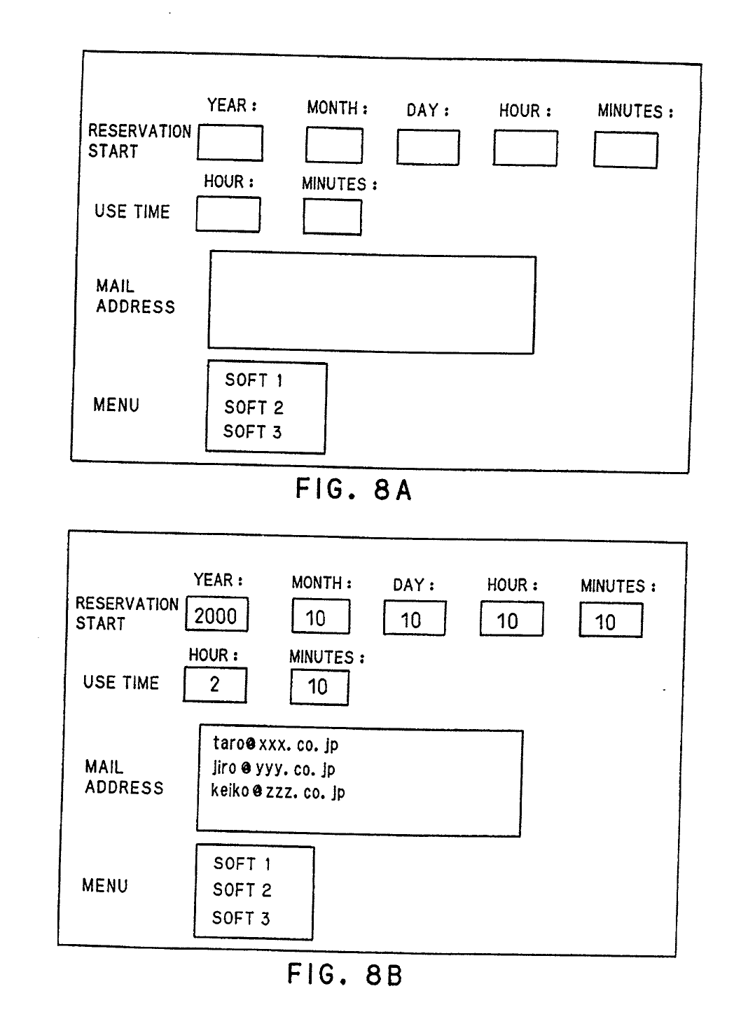

The application form appending description is transmitted to the client 1 (step S203) and after entry in the form, the entered form is returned to the server (step S204). Any format of the form is available, and for example, the form shown in FIG. 8A is prepared, and the date and time of mini LAN reservation start, use time, and client mail address in the group are entered, and the software supplied by the mini LAN is selected. FIG. 8B is a confirmation screen of input items.

These forms are recorded in the terminal of the client and it is desirable to use them next time, keep them linked with the address book at the terminal, and prepare a program for enabling easy entry of a mail address.

The server inquires the service giving schedule store 20 from the input date and time of mini LAN reservation start, use time, and number of clients in the group and performs the free IP address check process (step S205).

When the IP address can be reserved, the server performs the mailing process of the entered form. When the IP address cannot be reserved, the process goes to the reservation receiving step (connector 6→connector 7). The server transmits a display packet indicating under the entry confirmation job for the client m to the client 1 (step S207) and transmits a mail for entry confirmation to the client m (step S208). The reason for using a mail is that all the clients in the group are not always contract clients.

The client m confirms entry and transmits a confirmation mail to the server (step S301). When the client m rejects entry, the server reports the condition to the client 1 and enters the standby state at the following step, which is not directly related to this embodiment, so that detailed description will be omitted.

Also for the client m, the server performs the same client confirmation process as the aforementioned and performs the process in that all clients are contract clients (time contract clients included).

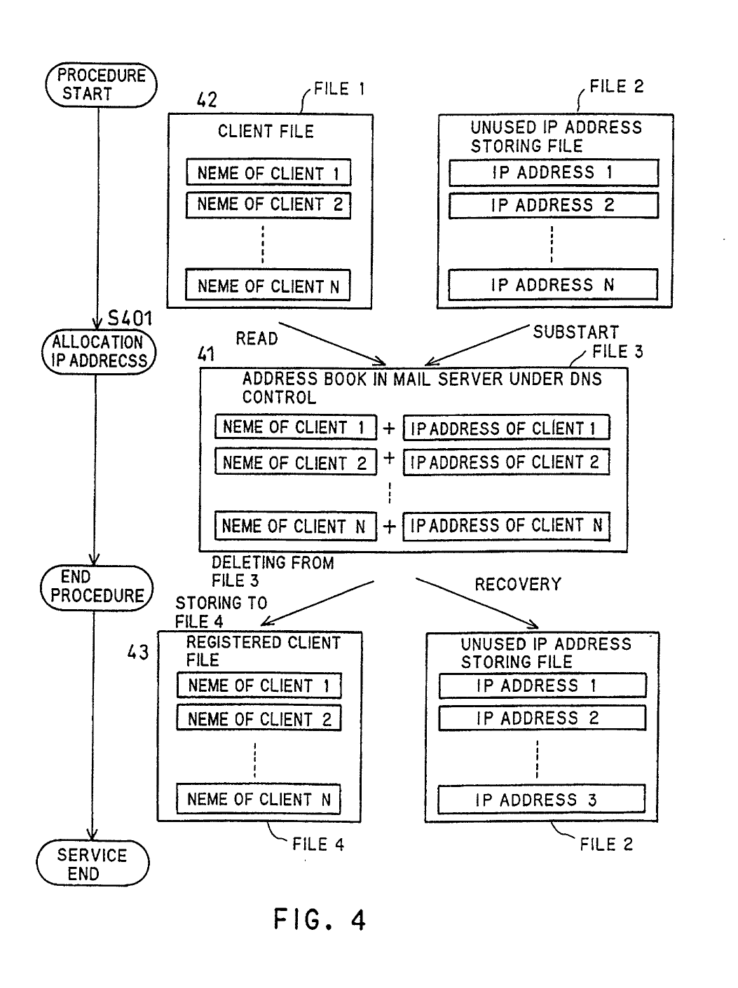

After end of the confirmation job, the reservation reception notification packets are transmitted to all the clients and five minutes before service start, as shown in FIG. 4, the IP addresses are assigned (step S401). Namely, IP addresses are extracted from the unused IP addresses for all the clients by the DNS and a correspondence table 41 with all the clients is prepared.

The server transmits the IP address setting file to all the clients and the client 1, after receipt, records the IP address setting file in the communication setting manager 26. The communication setting manager 26 reads the connection destination environment file including the said IP address and prepares a communication pass 1 for communicating with the mini LAN by the connection destination setting process.

Each time contract client has a communication means with another provider, so that the communication means during use of the mini LAN is set so as to be switched by the communication setting manager 26 at the request of the client.

The mini LAN service is started in this way.

Next, the process of the server in the LAN access controller 14 will be explained. In the DNS of the server, the IP address assignment is limited so that the IP addresses to be used in the mini LAN can be distinguished from the IP addresses to be used in the other LANs.

For example, as shown in table 2, when the IP addresses managed by the DNS are within the range (1), among the fourth numerals, 0 to 150 are used for the mini LAN (the range (2)) and 151 to 255 are used for the others (the range (3)).

TABLE 2
Allocation of IP address

| | |
|---|---|
| Range(1) | 190.130.200.0-190.130.200.255 |
| Range(2) | 190.130.200.0-190.130.200.150 |
| Range(3) | 190.130.200.151-190.130.200.255 |

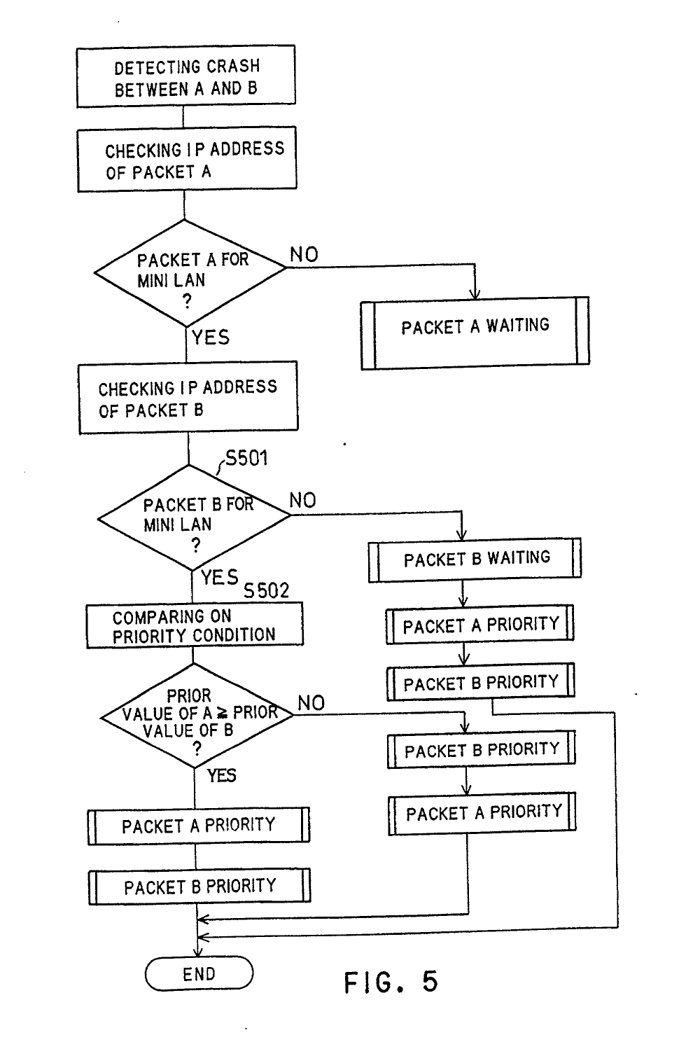

Therefore, the access control means at the time of packet collision compares the fourth numerals. For example, when the procedure shown in FIG. 5 is used, assuming the IP address of the packet A as 190.130.200.150 (address for the mini LAN) and the IP address of the packet B as 190.130.200.200 (address for the others), at the second decision stage (step S501), it is decided that the process of the packet A is given priority.

When both packets A and B are for the mini LAN, they are compared depending on the priority condition (step S502) and each priority condition is set as shown in Table 3.

TABLE 3
Priority condition

| | <Criterion> | <Priority Proceeding> |
|---|---|---|
| Condition | Recent access | More frequency is. |
| (1) | frequency. | |
| Condition | All clients number. | More client number is. |
| (2) | | |
| Condition | In order of application. | Earlier application is. |
| (3) | | |

Next, the preparation method for a connection environment setting file will be explained by referring to FIG. 6.

Firstly, with respect to the client name of a time contract client, as shown in a frame 61 in FIG. 6, “@” in the client mail address taro@xxx.co.jp is converted to “.”, and a client name of taro.xxx.co.jp is prepared, and as a result, an address of taro.xxx.co.jp@minilan.co.jp is set. Further, the password 123456ab is assigned optionally.

The client name is preserved in a client file 42 shown in FIG. 4. A connection environment setting file with the client name, password, and domain name is prepared and transmitted to the respective clients. Even if each client receives the file, no IP address is set at this time, so that no connection environment for the mini LAN is ready on the client.

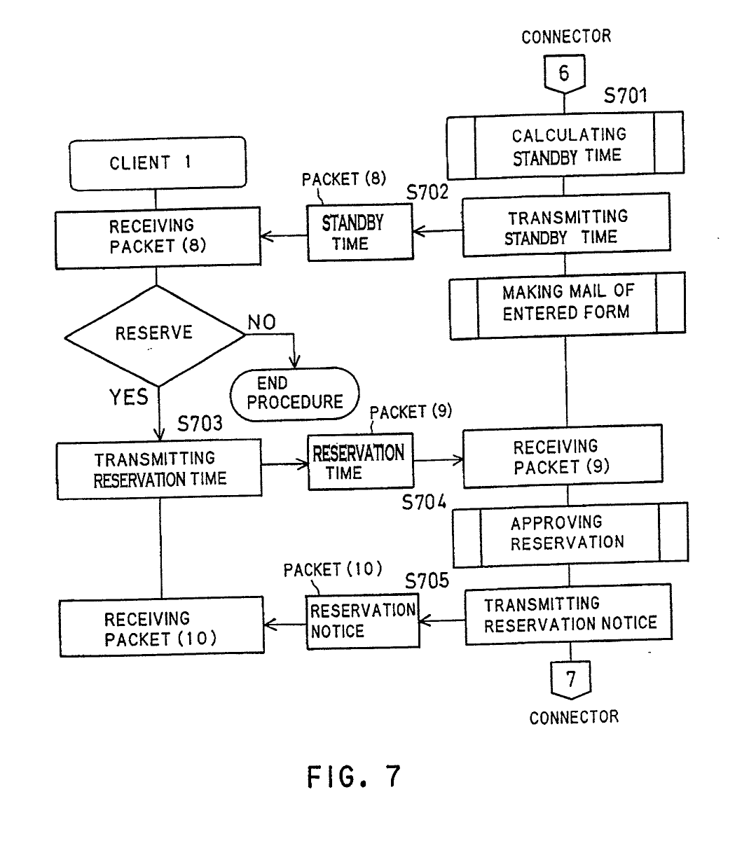

Next, the reservation receiving method will be explained by referring to FIG. 7.

Firstly, the server inquires the service giving schedule store 20 by the standby time calculation process (step S701), retrieves a fastest time zone for reserving the IP addresses for all the clients, and calculates the standby time. The server transmits the calculated standby time to the client 1 (step S702) and obtains his agreement of whether or not to reserve. When no agreement is obtained, the server goes to the end procedure that will be described later.

When his agreement is obtained, the client 1 transmits the reservation time (step S703) and the server inquires the service giving schedule store and performs the reservation receiving process for recording the reservation time in the schedule (step S704). After the process, the server transmits the reservation receiving notification to the client 1 again (step S705).

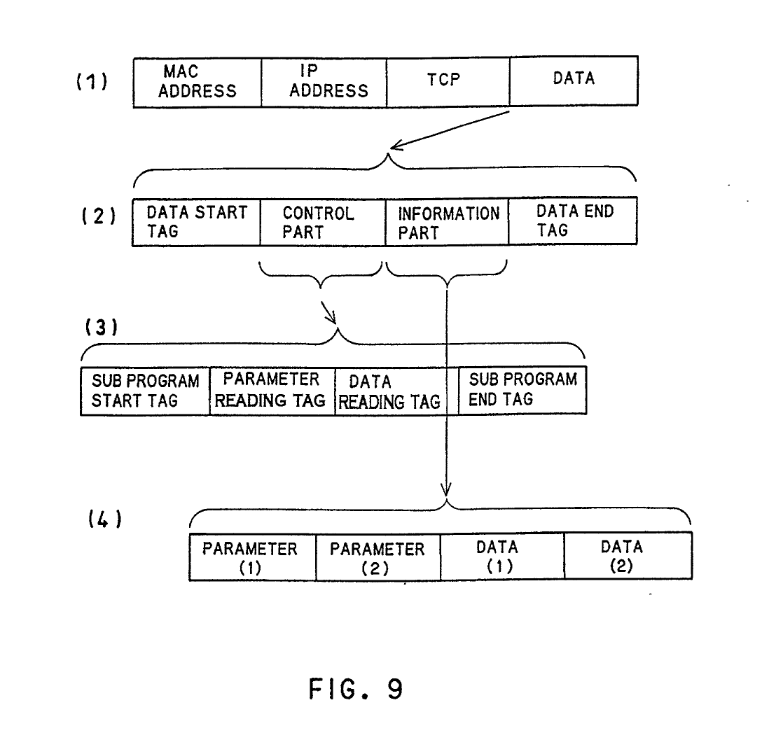

FIG. 9 is a drawing for explaining the packet format used for the mini LAN. The general-purpose OSI (open system interconnection) reference model is composed of, as shown in FIG. 9 (1), the MAC address (media access control address), IP address, TCP (transmission control protocol), and data including other communication layers.

As shown in FIG. 9 (2), the data division includes the data format for the mini LAN. The mini LAN data is basically composed of a data start instruction statement (hereinafter, an instruction statement is called a tag), the control division, information division, and a data end tag and the control division is composed of a subprogram start tag, a parameter reading tag, a data reading tag, and a subprogram end tag so as to operate the subprogram of the mini LAN.

The information division is composed of one or a plurality of parameters (two parameters are shown in the drawing) and one or a plurality of data (two data are shown in the drawing) and they are input to the display file by the parameter reading tag and data reading tag in the control division.

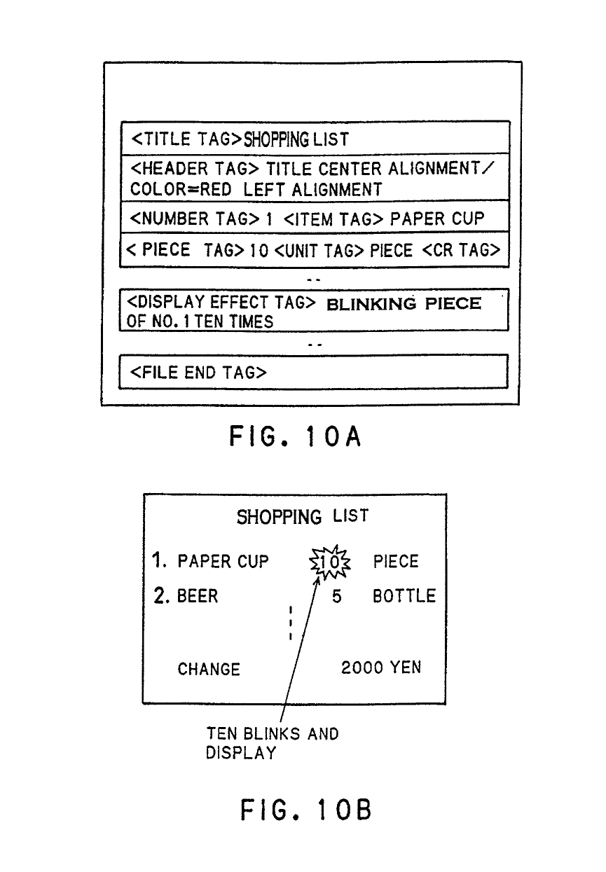

The display file, as shown in FIG. 10A, for example, is described by various tags and data subsequent to them, instructs partially flickering display as shown in FIG. 10B by the display effect tag as shown in the file, and produces the display effect indicated in the display example.

The display file format may be based on the HTML (hyper text markup language) format that can be read by the web browser.

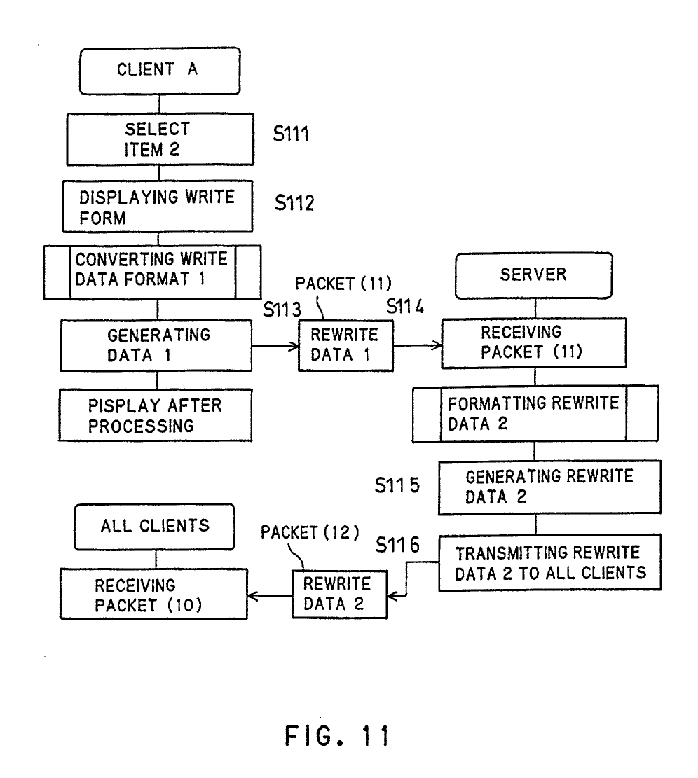

FIG. 11 shows an example indicating the procedure of the mini LAN job, which is a method for rewriting a part of the image. For example, in the second item shown in FIG. 10B, at the time of rewriting the number (5) of the item (beer), the item 2 is selected first (step S111). The item is originally entered in the item 2, so that it is judged that rewriting process is needed and the writing form (not shown in the drawing) appears (step S112).

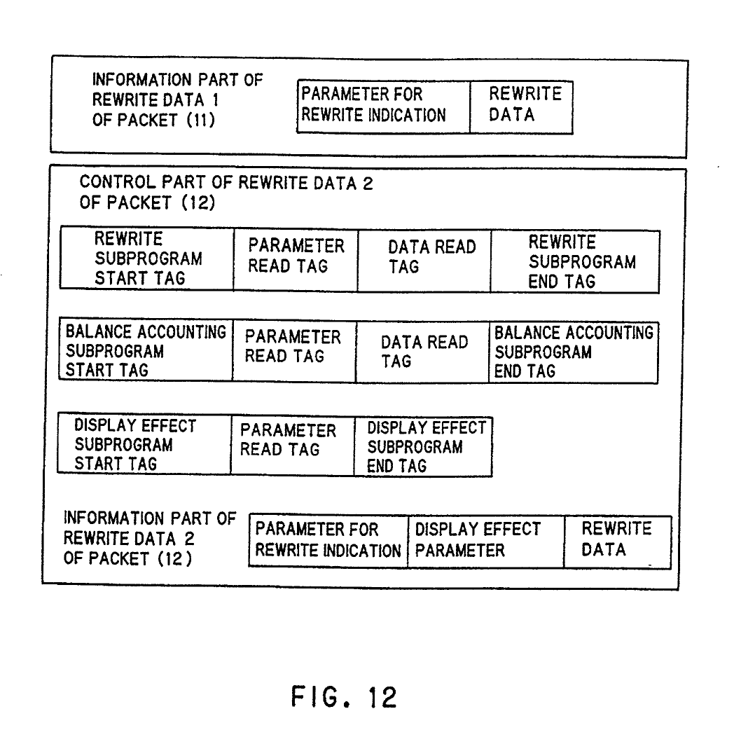

When the entry is finished and “Transmission” is selected, the rewriting data format conversion process 1 is performed (step S113) and rewriting data 1 is generated and transmitted (step S113). The rewriting data, as shown in FIG. 12, is composed of a parameter for instructing the information division a rewriting command and rewriting data so as to obtain a minimum packet.

Upon receipt of the data (step S114), the server generates rewriting data 2 that the control division and information division for starting the rewriting subprogram, balance calculation subprogram, and display effect subprogram are added to the rewriting data (step S115). Then, the server transmits the writing data 2 to all the clients (step S116).

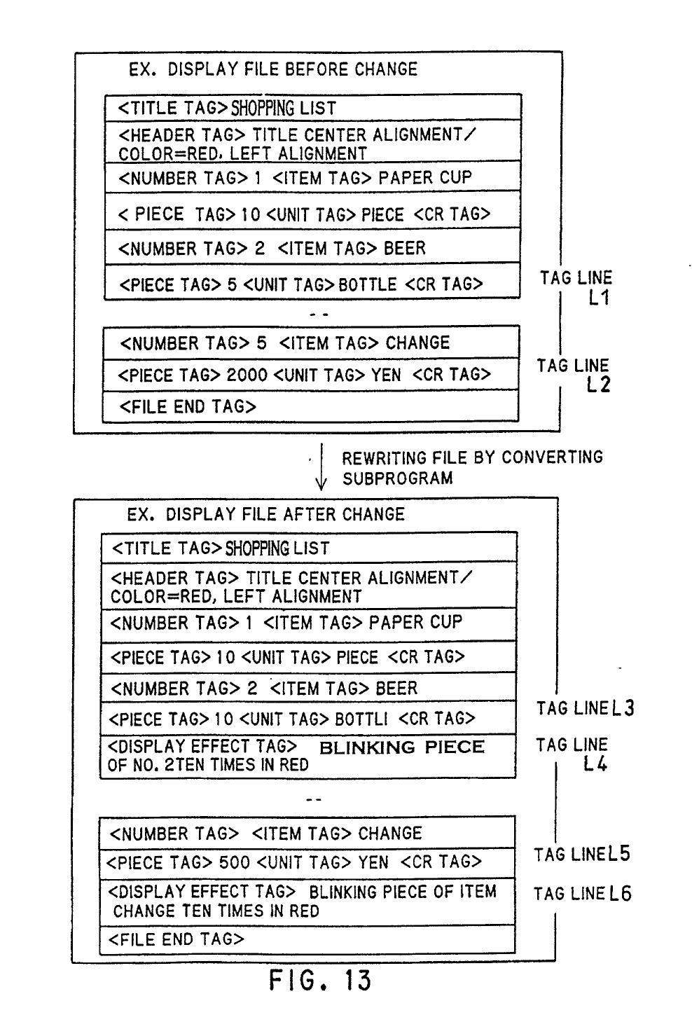

The display file before conversion and the display file after conversion are shown in FIG. 13. The tag lines L1 and L2 before conversion are rewritten to L3, L4, L5 and L6 after conversion.

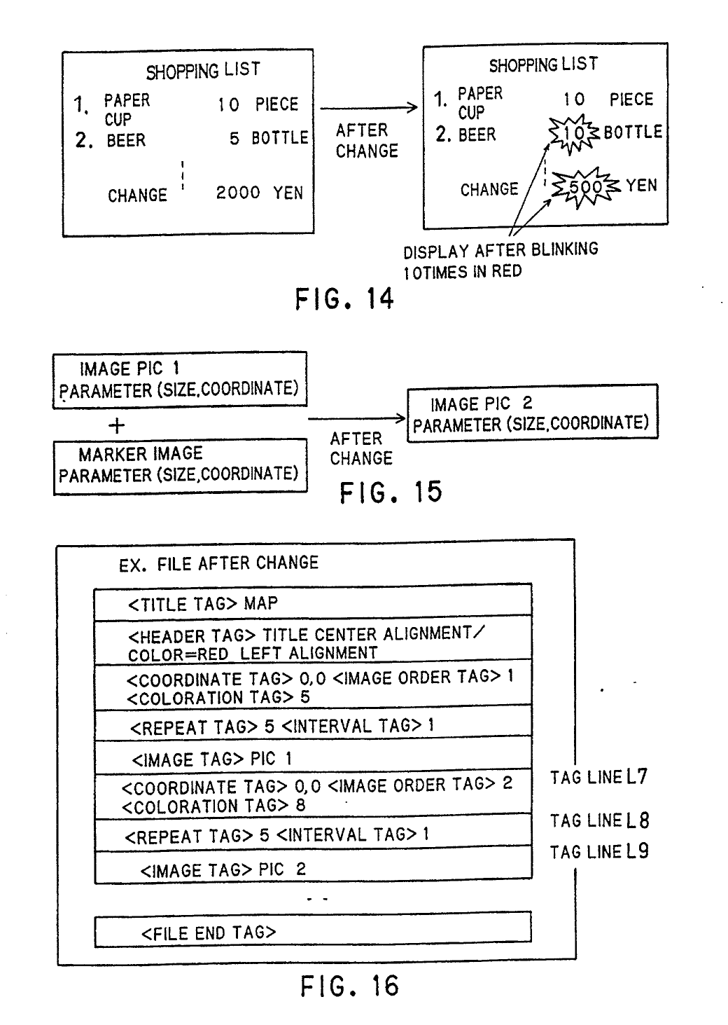

FIG. 14 shows display examples before and after conversion and it shows that the rewritten parts flicker image. As other examples, there are subprograms for handling images, which are shown in FIGS. 15 to 18A, 18B, 18C.

The display file is composed of image data and parameters of the size (numbers of longitudinal and lateral pixels) and the position coordinates on the upper left. When a target marker image is added to the image, as shown in FIG. 15, a converted image pic2 is prepared from the original image pic1. This job is also performed by the subprogram.

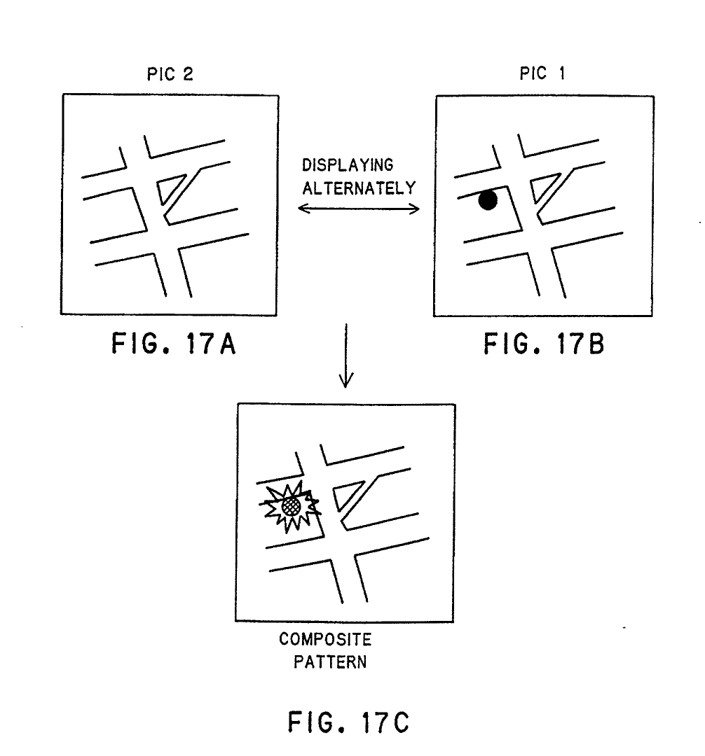

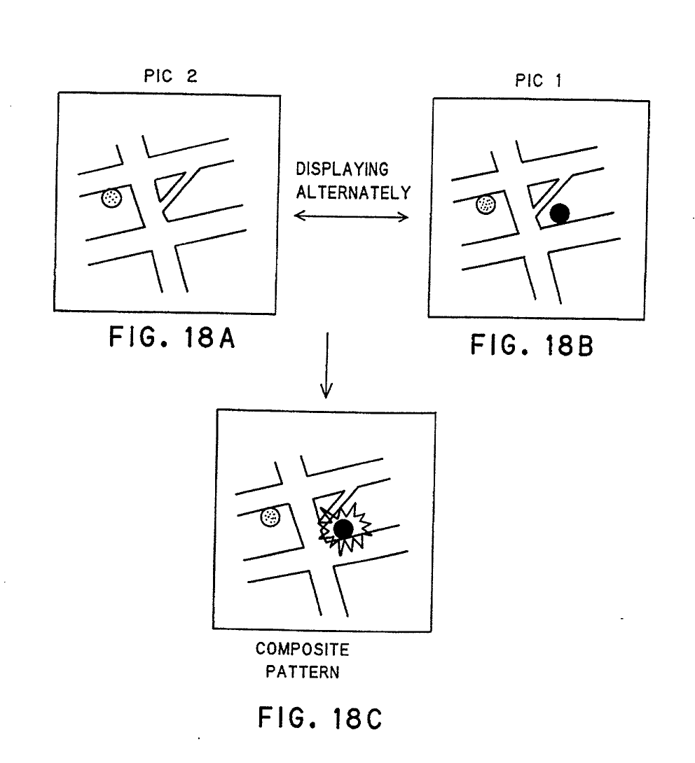

When the two display files are displayed according to the display file shown in FIG. 16, a display pattern that pic1 and pic2 appear alternately five times can be executed. The display pattern is shown in FIGS. 17 and 18. In FIG. 17A, there is no marker in pic2 and there is a marker in pic1 in FIG. 17B, so that in the composite pattern, the marker is flickering(FIG. 17C). In FIG. 18A, in pic2, a thin marker is displayed and in pic2, a thin marker in the same way as with the aforementioned and a thick marker are displayed in FIG. 18B, so that a composite display pattern that the thin marker is kept unchanged and the thick marker is flickering (FIG. 18C).

In this way, information can be given that the target moves from the position of the thin marker to the flickering position of the thick marker.

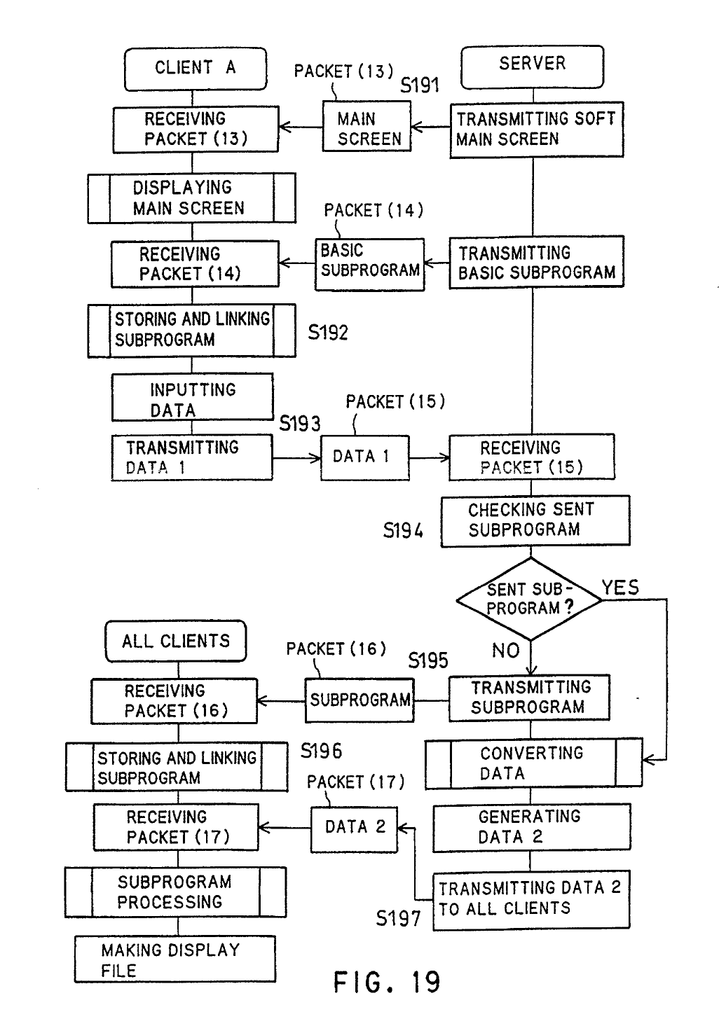

Next, the procedure for down-loading the mini LAN software from the server to a client will be explained by referring to FIG. 19.

The server transmits the main screen of the selected software to a client (it is assumed as a client A here) (step S191) and the main screen is displayed in the client. Continuously, only the basic subprogram (subprogram necessary to the software) used in the aforementioned software is transmitted and stored in the subprogram store 24 shown in FIG. 1 and linked with the main program (step S192).

When the client A inputs and transmits data (step S193), the server side retrieves a subprogram necessary to display the data and checks whether the subprogram is transmitted (step S194). When it is not transmitted, the server transmits the subprogram to all the clients (step S195) and performs the subprogram storage linking process (step S196).

After processing or when the subprogram is transmitted, the server converts the data and then transmits the data 2 to all the clients (step S197) and the display file is rewritten via the subprogram process. This procedure has an effect for minimizing transmission of the subprogram relating to the software.

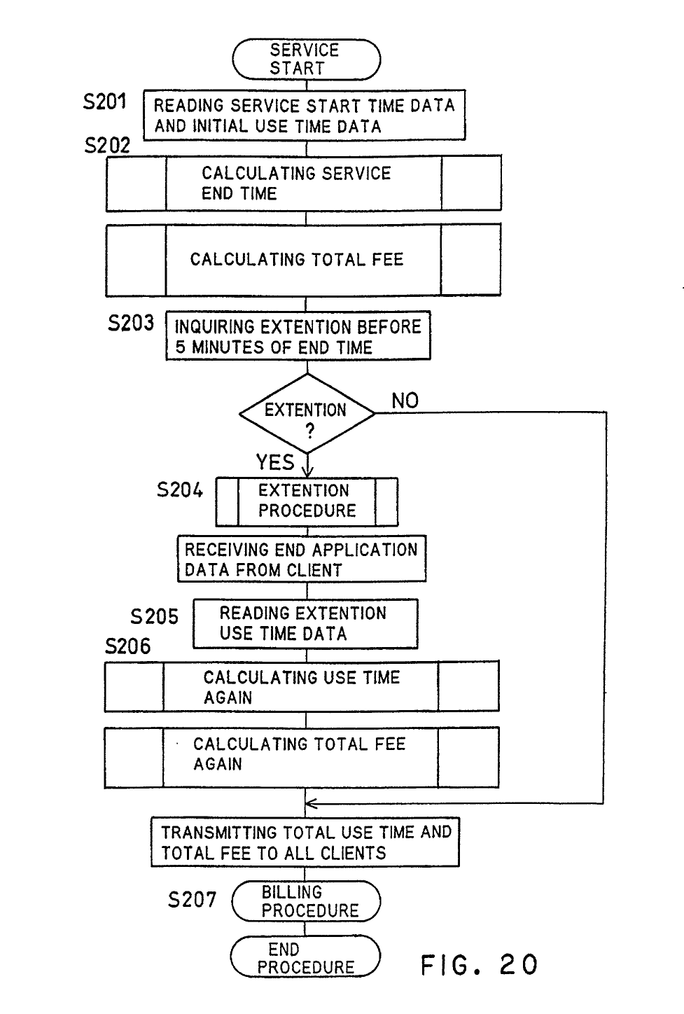

Next, the end time calculation and charge calculation performed by the server during the service period will be explained. As shown in FIG. 20, after service start, the service start time data and initial setting use time data are read from the data entered in the application form shown in FIG. 8 (step S201).

The server performs the service end time calculation process (service start time+initial setting use time=service end time) and the total fee calculation process (mini LAN fixed amount charge+(initial setting use time charge per each client+number of used packets per each client)×number of clients=total charge within initial setting use time range) (step S202).

Five minutes before the end time, the server inquires the client 1 about desire of extension (step S203). When the server receives desire of extension, the server inquires the service giving schedule store 20 and performs the extension procedure process for checking availability of extension (step S204). When the extension is available, a procedure of informing the reservable time to clients is adopted.

A mechanism for ending the service freely, for example, at an interval of one minute after extension is prepared and upon receipt of application data of service end from the client 1, the server reads the extended use time (step S205).

Then, the server performs the use time recalculation process (initial setting use time+extended use time=total use time) and the total fee recalculation process (charge within initial setting use time range+(extended use charge for one minute per each client×extension charge+initial setting use time charge per each client+number of used packets per each client)×the number of clients=total charge) (step S206).

The server transmits the calculation result including a case of non-extension to the client 1 and goes to the billing procedure (step S207).

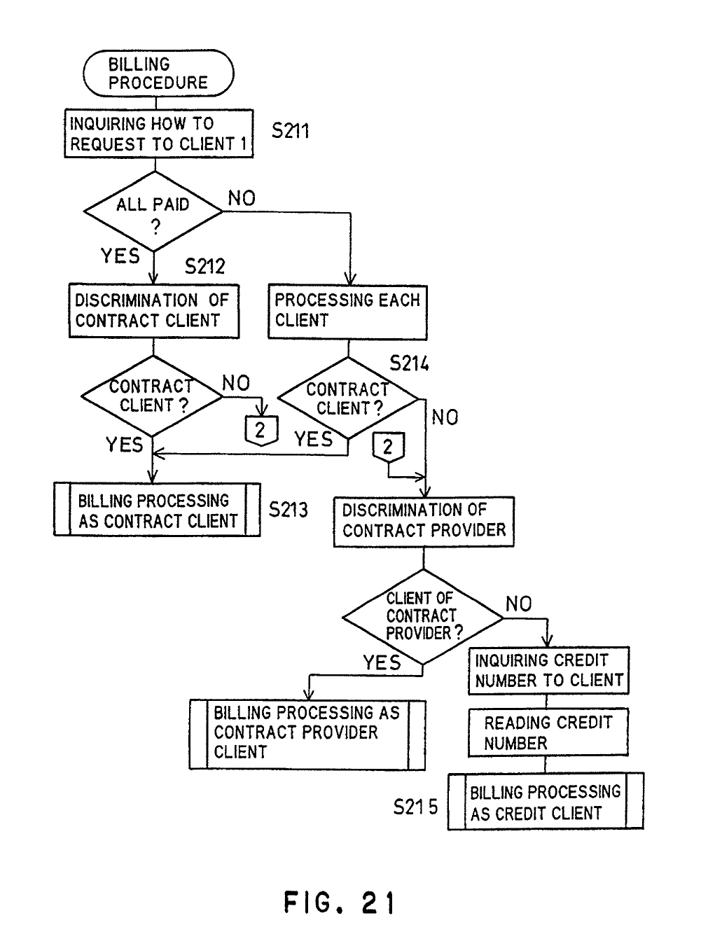

Next, the billing procedure will be explained by referring to FIG. 21. The server inquires the client 1 about the request method of payment of the fee in full by himself or payment in installments by all clients (step S211).

In the case of payment in full by the client 1, the server decides whether the client 1 is a contract client or a time contract client (step S212). When the client 1 is a contract client, the server can perform the billing process directly from the mini LAN provider (provider owning the mini LAN server) (step S213).

On the other hand, when the client 1 is a time contract client, the server decides whether the client 1 is a client of the contract provider who contracts with the mini LAN provider for the billing system (step S214). When the client 1 is a client of the contract provider, the server can perform the billing process via the contract provider.

When the client 1 is other than them, payment by a credit card is possible and the server inquires the client 1 about the credit card number and performs the billing process by a credit card (step S215).

Also in the case of payment in installments by all clients, the server performs the same process for each client.

Next, the end procedure will be explained. In this system, for the next use of the mini LAN, as shown in FIG. 4, the client name of the user is preserved in a registered client file 43 and the IP address is collected. It is desirable to also preserve the connection environment setting file. By doing this, for a registered client, the time required from requesting to open the mini LAN to service start can be shortened.

According to the present invention, a network environment is provided in the group, so that between clients connected to the network and between a client and the server, they can mutually access the data bases of the clients and the data base of the server. Such a job is ordinarily performed in the network environment, so that it will not be described in detail.

According to the present invention, within the time range designated by a client, the access priority in the network prepared by the server can be increased, so that the operation efficiency requiring real-time processing in the short-time corroboration job can be improved.

What is claimed is:

1. A method for providing a network environment as requested from a plurality of clients, comprising:
receiving a request to provide said network environment from one of said clients,
setting an individual network for each of said clients requesting to provide a closed network in response to the received request and informing to said client of use permission with a predetermined discriminator and an access priority, and
managing a use time of said closed network.

2. A method for providing a network environment as requested from a plurality of clients, comprising:
a step of requesting to provide said network environment from said clients,
a step of setting an individual network for each of said clients requesting to provide a network at said requesting step by said server and informing said client of use permission of a predetermined discriminator,
a step of giving said discriminator informed at said setting and informing step access priority to said individual network and starting measurement of a use time of said network,
a step of inquiring said client about whether or not to extend when said network use time with measurement started at said giving and starting step passes a predetermined time, and
a step of extending said network use time when said client requests for extension for said inquiry at said inquiring step.

3. A system for providing a network environment as requested from a plurality of clients, comprising:
means for requesting to provide said network environment from said clients,
means for setting an individual network for each of said clients requesting to provide a network by said requesting means by a server and informing said client of use permission of a predetermined discriminator, and
means for giving said discriminator informed by said setting and informing means access priority to said individual network and managing a use time of said network.

4. A server for providing a network environment with a plurality of clients, comprises:
a receiver configured to receive a message transmitted from one of said clients,
a data converter configured to convert said message according to an environment of said client,
a transmitter configured to transmit said message after conversion,
an access controller configured to control accessing in said network in consideration of access priority by a discriminator included in said message,
a client manager configured to check said discriminator of said client,
a schedule storage storing time management information of said network, and
a network environment manager configured to manage said network with the access priority.

5. A client device used in a system for providing a network environment with other client devices and a server, the client device comprising:
communication device configured to communicate with said server,
a communication setting manager configured to prepare for communication passes with said server,
a receiver configured to receive a message transmitted from said server,
a store configured to store said message,
a converter configured to convert said message into a display data format and convert input data to a message, and
a terminal job manager configured to manage said communication data conversion.

6. A server for providing a network environment with a plurality of clients according to claim 4,
wherein said access priority is decided from an Internet protocol address of said client.

7. A client device used in a system for providing a network environment with other client devices and a server according to claim 5,
wherein said converter has a main program operating regardless of a software environment used by said client and a plurality of subprograms operating according to said software environment used by said client, the system starts said subprograms according to said kind of said data in said message, and converts said display file.

8. A server for providing a network environment with a plurality of clients, according to claim 4,
wherein said server further has a service giving means for billing said client according to a use time designated by said client and an extended time used by said client.

9. A local network service providing method for a server which are capable to communicate with a plurality of client devices via a communication network, comprising:
receiving a local network service request from a contract client device which represents a group of client devices,
wherein each of client devices in the group uses a local network service being requested;
making a contract with the contract client for a reservation of the local network service, wherein the contract includes at least an allowed use time of the local network service;
establishing communication passes with each of client devices included in the group to allow each of client devices to use the local network; and
monitoring an actual use time of the local network to compare with the allowed use time.
